(19) United States
(12) Patent Application Publication
(10) Pub. No.: US 2025/0355600 A1
(43) Pub. Date: Nov. 20, 2025

(54) IMAGE FORMING APPARATUS, METHOD FOR CONTROLLING THE SAME, AND STORAGE MEDIUM

(71) Applicant: CANON KABUSHIKI KAISHA, Tokyo (JP)

(72) Inventor: TOMOHIRO KIMURA, Chiba (JP)

(21) Appl. No.: 19/205,134

(22) Filed: May 12, 2025

(30) Foreign Application Priority Data
May 17, 2024 (JP) 2024-080806

(51) Int. Cl. G06F 3/12

(52) U.S. Cl. CPC G06F 3/1203; G06F 3/1222; G06F 3/123; G06F 3/1236; G06F 3/1286; G06F 3/1287; G06F 3/1288

(57) ABSTRACT

An image forming apparatus that communicates with an external apparatus controls estimation processing for estimating a usage environment of the image forming apparatus using information based on communication packets communicated by the image forming apparatus, and issues a notification corresponding to a result of the estimation processing, wherein, in a case where the image forming apparatus is set to a specific mode, control is performed to prevent the estimation processing from being executed.

### BACKGROUND

### Field

The present disclosure relates to a technique for estimating the usage environment of an image forming apparatus.

### Description of the Related Art

Various security-related functions of an information apparatus need to be suitably set as security measures. If setting values optimized for a single usage environment are applied to an information apparatus to be used in the single fixed usage environment at the time of shipment, the user can use the information apparatus provided with suitable security measures, without being conscious of security.

Multi-Function Peripherals (MFPs) have been used in diverse usage environments, more specifically, not only in office environments but also in teleworking environments and public spaces shared by unspecified persons. Since suitable security settings differ according to usage environments, each usage environment requires suitable setting values.

Japanese Patent Application Laid-Open No. 2019-22099 discusses a technique for assisting to collect operating statuses of test networks, generate policies of the networks, and update the policy of each network. The technique in Japanese Patent Application Laid-Open No. 2019-22099 compares feature quantities extracted from communication packets with the policy to detect a network failure.

However, if the usage environment of an apparatus is estimated, for example, during the manufacturing process, maintenance work, or other specific operating states, the result of the estimation may possibly differ from the result of the estimation in the normal operation.

### SUMMARY

The present disclosure is directed to controlling processing for estimating a usage environment.

According to an aspect of the present disclosure, an image forming apparatus that communicates with an external apparatus controls estimation processing for estimating a usage environment of the image forming apparatus using information based on communication packets communicated by the image forming apparatus, and issues a notification corresponding to a result of the estimation processing, wherein, in a case where the image forming apparatus is set to a specific mode, control is performed to prevent the estimation processing from being executed.

Further features of the present disclosure will become apparent from the following description of exemplary embodiments with reference to the attached drawings.

### BRIEF DESCRIPTION OF THE DRAWINGS

FIG. 1 illustrates a system configuration of an exemplary embodiment.

FIG. 2 illustrates an example configuration of a controller unit of a Multi-Function Peripheral (MFP).

FIG. 3 illustrates an example of a functional configuration of the controller unit of the MFP.

FIG. 4 illustrates a screen configuration related to security setting.

FIG. 5 is a flowchart illustrating an example of estimation processing execution according to an exemplary embodiment.

FIG. 6 illustrates an input/output structure using a learning model.

FIG. 7 is a table illustrating examples of operation modes according to an exemplary embodiment.

FIG. 8 is a table illustrating examples of usage environments according to an exemplary embodiment.

FIG. 9 is a table illustrating examples of communication feature information used in the estimation processing according to an exemplary embodiment.

### DESCRIPTION OF THE EMBODIMENTS

Exemplary embodiments of the present disclosure will be described below with reference to the accompanying drawings.

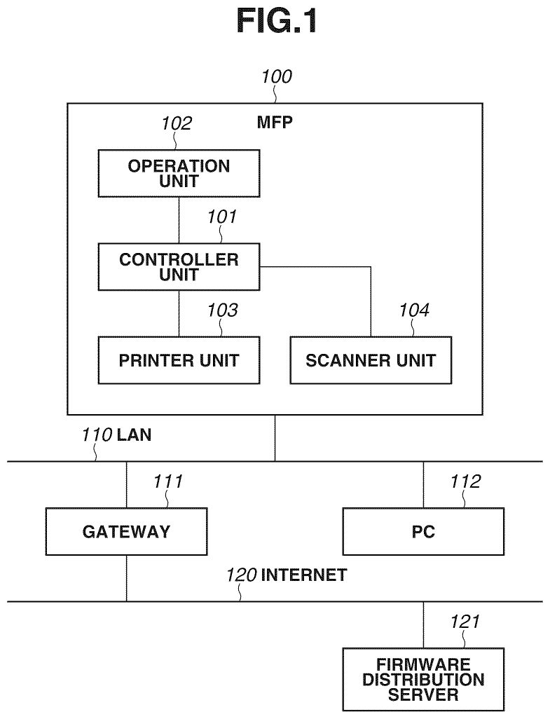

FIG. 1 illustrates a connection configuration of a Multi-Function Peripheral (MFP) 100, a gateway 111, and a firmware distribution server 121 according to an exemplary embodiment. The MFP 100 and the firmware distribution server 121 are communicably connected with each other via a Local Area Network (LAN) 110, a gateway 111, and the Internet 120. The MFP 100 and the firmware distribution server 121 are also communicably connected with other apparatuses.

The firmware distribution server 121 is managed by an MFP vendor to distribute updated firmware. The MFP 100 can acquire the updated firmware from the firmware distribution server 121 and update the firmware installed on the MFP 100.

The MFP 100 includes an operation unit 102 for performing input and output operations with a user, a printer unit 103 for outputting electronic data to a paper medium, and a scanner unit 104 for scanning a paper medium and converting the data on the paper medium into electronic data. The operation unit 102, the printer unit 103, and the scanner unit 104 are communicably connected with a controller unit 101 to implement their respective functions under control of the controller unit 101. While in the present exemplary embodiment the MFP 100 is provided as an example of an image forming apparatus, this is not seen to be limiting. The image forming apparatus may be a Single Function Peripheral (SFP) such as a scanner or a printer. The image forming apparatus may also be a general information processing apparatus, such as for example, a personal computer.

The gateway 111 is a network router for relaying communication between the MFP 100 and the Internet 120.

A personal computer (PC) 112 is an information processing terminal used by a user of the MFP 100. The user of the MFP 100 operates the PC 112 to use the functions of the MFP 100. By downloading in advance a firmware update to the PC 112 and then sending the firmware update from the PC 112 to the MFP 100, the user can update the MFP's 100 firmware without using the firmware distribution server 121.

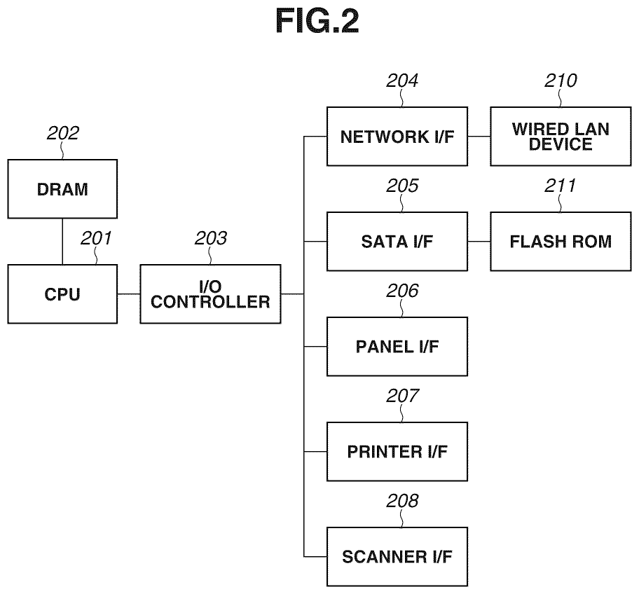

FIG. 2 is a block diagram illustrating an example configuration of the controller unit 101 of the MFP 100. A central p unit (CPU) 201 performs a main calculation processing in the controller unit 101. The CPU 201 is connected with a Dynamic Random Access Memory (DRAM) 202 via a bus. The DRAM) 202 is used by the CPU 201 as a working memory for storing processing target data and program data representing calculation instructions in the calculation process of the CPU 201. The CPU 201 is connected with an I/O controller 203 via a bus. The I/O controller 203 performs input and output operations for various devices based on instructions of the CPU 201.

The I/O controller 203 is connected with a Serial Advanced Technology Attachment (SATA) interface (I/F) 205. The SATA I/F 205 is connected with a Flash Read Only Memory (ROM) 211.

The CPU 201 uses the ROM 211 to store programs and document files for implementing the functions of the MFP 100, a learned model used for estimation processing, storing learned communication tendencies for usage environments, and operation mode information. The I/O controller 203 is connected with a network I/F 204. The network I/F 204 is connected with a wired LAN (WLAN) device 210. The CPU 201 controls the WLAN device 210 via the network I/F 204 to implement communication on the WLAN 210.

I/O controller 203 is connected with a panel I/F 206. The CPU 201 implements user input and output operations on the operation unit 102 via the panel I/F 206. The I/O controller 203 is connected with a printer I/F 207. The CPU 201 implements output processing on a paper medium using the printer unit 103 via the printer I/F 207. The I/O controller 203 is connected with a scanner I/F 208. The CPU 201 implements processing for reading a document of a paper medium using the scanner unit 104 via the scanner I/F 208.

When performing the copy function, the CPU 201 reads program data from the ROM 211 to the DRAM 202 via the SATA I/F 205. Based on the program read in the DRAM 202, the CPU 201 detects a copy instruction from the user to the operation unit 102 via the panel I/F 206. Upon detection of the copy instruction, the CPU 201 receives the document as image data from the scanner unit 104 via the scanner I/F 208 and then stores the image data in the DRAM 202. The CPU 201 subjects the image data stored in the DRAM 202 to color conversion processing suitable for output. The CPU 201 transfers the image data stored in the DRAM 202 to the printer unit 103 via the printer I/F 207, and then performs processing for outputting the image data to a paper medium.

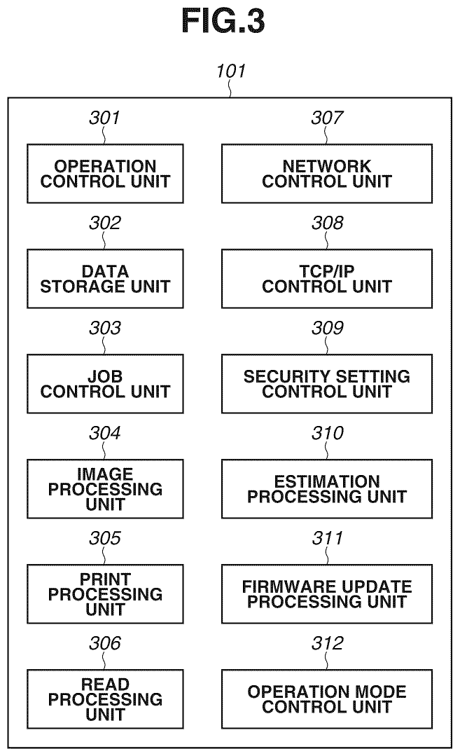

FIG. 3 is a block diagram illustrating an example of a functional configuration implemented by software executed by the controller unit 101 of the MFP 100. The controller unit 101 executes the software after the CPU 201 has read programs stored in the ROM 211 into the DRAM 202.

An operation control unit 301 displays a screen on the operation unit 102 to the user, detects user operations, and performs processing associated with buttons and other components displayed on the screen. The data storage unit 302 writes and reads data to/from the ROM 211 upon request from other control units. For example, if the user wants to change a certain device setting, the operation control unit 301 detects the value input to the operation unit 102 by the user. Upon request from the operation control unit 301, the data storage unit 302 stores the user input as a setting value in the ROM 211. The operation control unit 301 reads learning model data to be used for the estimation processing.

A job control unit 303 controls job execution according to instructions from other control units. An image processing unit 304 processes the image data into a format suitable for each application based on an instruction from the job control unit 303. A print processing unit 305 prints an image on a paper medium via the printer I/F 207 based on an instruction from the job control unit 303. A read processing unit 306 reads a document via the scanner I/F 208 based on an instruction from the job control unit 303.

When the system is activated or a setting change is detected, a network control unit 307 performs network setting such as the internet protocol (IP) address to a Transmission Control Protocol/Internet Protocol (TCP/IP) control unit 408 based on the setting values stored in the data storage unit 302. The TCP/IP control unit 308 performs network packet communication processing via the network I/F 204 based on instructions from other control units.

A security setting control unit 309 performs control related to the security setting of the MFP 100. The security setting control unit 309 manages the correspondence relation between a usage environment (such as in-house intranet, home, public space environments, etc.) and corresponding security-related setting items. This enables collectively setting the corresponding security-related setting at a timing when the user specifies the usage environment. The security setting control unit 309 uses the data storage unit 302 to reference and change the setting values.

An estimation processing unit 310 executes usage environment estimation processing at a timing when the system is activated, a screen is displayed, or a predetermined time period has elapsed. The estimation processing unit 310, for example, uses the network control unit 307 to acquire communication feature information regarding data communication performed by the MFP 100. The estimation processing unit 310 extracts, for example, destination and source IP addresses, TCP/(user datagram protocol) UDP type, port number, and IP header information from the information accompanying network packets. The estimation processing unit 310 uses the acquired information as input data and derives the most approximate usage environment as an estimation result by using a learned model read from the data storage unit 302.

A firmware update processing unit 311 updates the programs for controlling the MFP 100. For example, the firmware update processing unit 311 acquires updating programs from the firmware distribution server 121 via the TCP/IP control unit 308. The firmware update processing unit 311 issues a request to the data storage unit 302 and writes the acquired updating programs to the ROM 211 to update the programs for controlling the MFP 100.

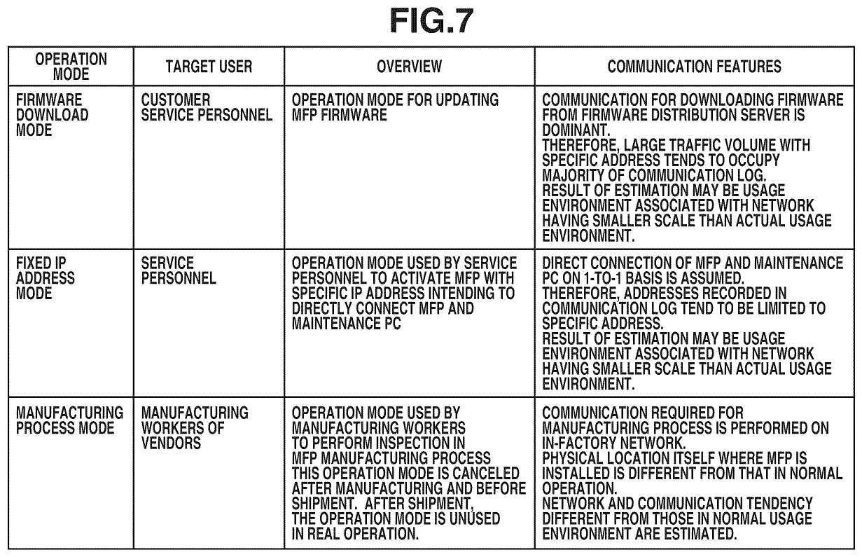

An operation mode control unit 312 performs operation mode control for the various operational modes of the MFP 100. In the example according to the present exemplary embodiment, the operation mode control unit 312 manages and controls the operation modes illustrated in the table in FIG. 7.

A firmware download mode is an example of an operation mode. This operation mode is used to update the firmware of the MFP 100. When the MFP 100 is set to the firmware download mode, the MFP 100 implements communication to download the firmware from the firmware distribution server 121, which can be the predominant communication being executed. This may result in a large-capacity traffic with a specific address occupying the majority of communication. Thus, the usage environment may be estimated as a usage environment associated with a network having a smaller scale than the actual usage environment.

A fixed IP address mode is another example of an operation mode. The operation mode is typically used by service personnel to activate the MFP 100 with a specific IP address intending to directly connect the MFP 100 and a maintenance PC. When the MFP 100 is set to the fixed IP address mode, it is presumed that the MFP 100 and the maintenance PC are directly connected with each other. This may result in addresses being recorded in the communication feature information being limited to specific addresses. Thus, the usage environment may be estimated to be a usage environment associated with a network having a smaller scale than the actual usage environment.

A manufacturing process mode is still another example of an operation mode. The manufacturing process mode is used by manufacturing workers to perform inspection work in the manufacturing process of the MFP 100. This operation mode is typically only active during the manufacturing process and is inoperable after this process is completed. When the MFP 100 is set to the manufacturing process mode, any communication required for the manufacturing process is typically performed on an in-factory network where the MFP 100 is manufactured. The physical location where the MFP 100 is ultimately installed is different from that in the normal operation, and the network and communication tendency different from those of the normal usage environment are estimated.

The operation mode of the MFP 100 is stored in the ROM 211, and changed by a target user's operation. For example, the fixed IP address mode is set in a setting menu screen (not illustrated) for service personnel. The example according to the present exemplary embodiment assumes that, when completing an operation mode change, the MFP 100 is reactivated to return to the normal operation mode. This example is not seen to be limiting. An operation mode setting method and the reactivation accompanying the change may be based on other methods.

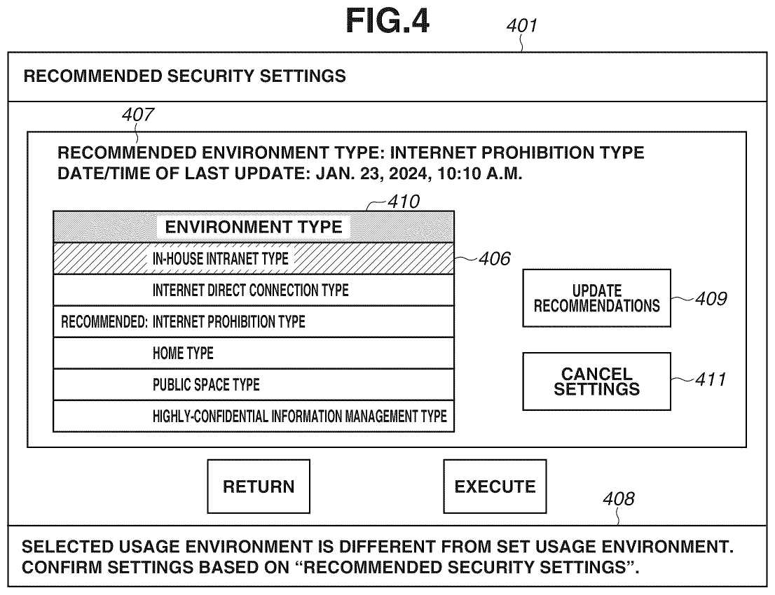

FIG. 4 illustrates a recommended security setting screen 401 displayed on the operation unit 102. Referring to FIG. 4, a usage environment selection list 410 is used to select a usage environment of the MFP 100. Selection operations for the usage environment selection list 410 enables the user to collectively set a series of security setting values suitable for each usage environment.

Currently selected usage environment display 406 displays the currently set usage environment of the MFP 100 selected in the usage environment selection list 410. The currently selected usage environment display 406 highlights the currently selected usage environment. More specifically, a set of setting values recommended for the usage environment in highlight display is set to the MFP 100. Information about the selected usage environment is stored in the data storage unit 302 when each corresponding button is selected. At this time, date/time information indicating when the button was selected is stored together with the former information. A usage environment estimation result display area 407 displays the usage environment of the MFP 100 estimated based on the tendency of the communication feature information through the estimation processing using a learned model, and information about the date/time when the estimation processing was performed. The usage environment estimation result display area 407 also displays “Recommended Environment Type” in association with the items of the usage environment obtained as a result of the estimation processing in the usage environment selection list 410. In this case, the usage environment estimation result display area 407 displays “Recommended Environment Type” based on the result and date/time of the last estimation process. More specifically, if the usage environment estimation processing is not to be executed in a specific operation mode, the usage environment estimation result display area 407 displays the result and date/time of the last estimation processing before a specific operation mode is set. An information display area 408 is used to notify the user of various kinds of information. For example, the information display area 408 displays the execution status and the execution result of the estimation processing.

An Update Recommendations button 409 is used to manually execute the usage environment estimation processing at any desired time.

A Cancel Settings button 411 is used to clear the settings of the currently selected usage environment. When the Cancel Settings button 411 is selected, information in the usage environment selection list 410 and the currently selected usage environment display 406 is reset, and the usage environment is un-set.

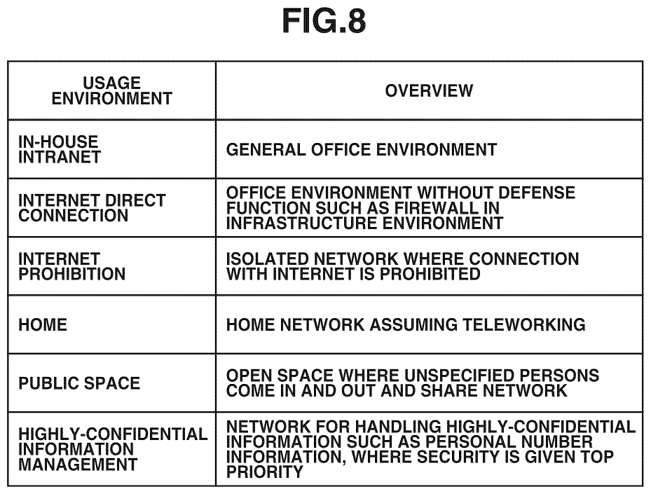

FIG. 8 illustrates a table of examples of usage environments used in the example according to the present exemplary embodiment. The present exemplary embodiment uses six different usage environments. For example, the in-house intranet environment is a general office environment. The Internet direct connection environment is an office environment that does not include any security precautions, such as a firewall in the infrastructure environment. The Internet prohibition environment is an isolated network environment where connection with the Internet is prohibited. The home environment is a home network environment. The public space environment is an open space environment where any person(s) can access and share a network. The highly-confidential information management environment is a network environment for handling highly-confidential information, such as personal number information, where security is a top priority.

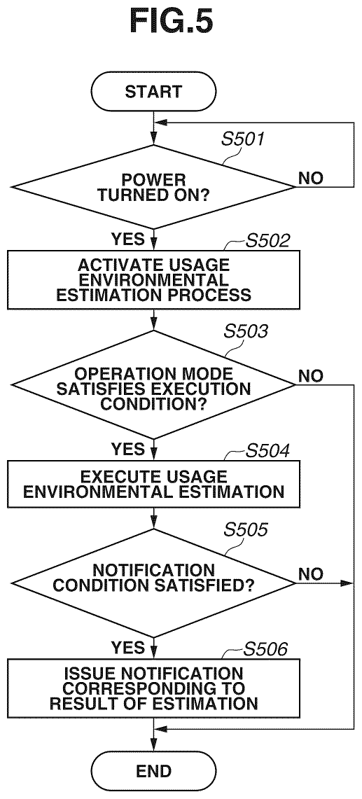

Estimation processing control according to the operation modes of the MFP 100 illustrated in FIG. 3 will be described below with reference to FIG. 5. FIG. 5 is a flowchart illustrating an example execution of the estimation processing according to the present exemplary embodiment. The processing of the flowchart in FIG. 5 is implemented when the CPU 201 reads a program stored in the ROM 211 into the DRAM 202 and then executes the program. Each step of the flowchart in FIG. 5 is executed by the estimation processing unit 310 in collaboration with the operation mode control unit 312 and the operation control unit 301 as required.

When the power of the MFP 100 is turned ON in step S501, the functions of the controller unit 101 illustrated in FIG. 3 are activated. More specifically, when the estimation processing unit 310 detects that the power of the MFP 100 is turned ON (YES in step S501), the processing proceeds to step S502. In step S502, the CPU 201 starts the process for estimating the usage environment.

In step S503, the estimation processing unit 310 collaborates with the operation mode control unit 312 to acquire information about the current operation mode from the data storage unit 302 and determine whether the operation mode of the MFP 100 satisfies the execution condition of the estimation processing. The execution condition according to the present exemplary embodiment is a condition where the operation mode of the MFP 100 does not coincide with any of the operation modes in the table in FIG. 7.

When the operation mode of the MFP 100 coincides with any of the operation modes in the table in FIG. 7, the operation mode control unit 312 determines that the operation mode does not satisfy the execution condition of the estimation processing. Therefore, the operation mode control unit 312 determines not to execute the estimation processing.

When the operation mode of the MFP 100 does not coincide with any of the operation modes in the table in FIG. 7, the operation mode control unit 312 determines that the operation mode satisfies the execution condition of the estimation processing. Therefore, the operation mode control unit 312 determines to execute the estimation processing.

When the operation mode control unit 312 determines not to execute the estimation processing (NO in step S503), the operation mode control unit 312 exits this flowchart without executing the estimation processing. More specifically, the operation mode control unit 312 terminates the usage environment estimation processing without executing the estimation processing in step S504 and the notification processing in step S506. When the operation mode control unit 312 determines not to execute the estimation processing, the operation mode control unit 312 may disable selection of the Update Recommendations button 409 to control the manual execution of the estimation processing by the Update Recommendations button 409. More specifically, when the operation mode control unit 312 collaborates with the operation control unit 301 to determine not to execute the estimation processing, the operation mode control unit 312 controls display so that the Update Recommendations button 409 cannot be selected when the screen 401 is displayed. After the power of the MFP 100 is turned ON, the operation mode control unit 312 controls display so that the Update Recommendations button 409 cannot be selected each time the screen 401 is displayed until the operation mode is determined to satisfy the execution condition in step S503.

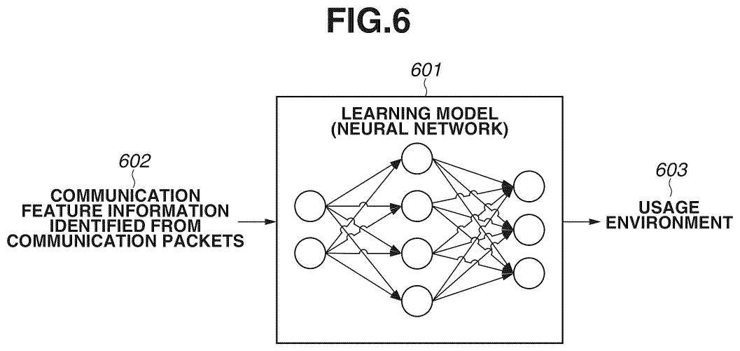

When the operation mode control unit 312 determines to execute the estimation processing (YES in step S503), the processing proceeds to step S504. In step S504, the operation mode control unit 312 requests the estimation processing unit 310 to execute the usage environment estimation processing. The estimation processing executed by the estimation processing unit 310 will be described in detail below with reference to FIG. 6. The estimation processing unit 310 then stores the result of the estimation processing via the data storage unit 302.

In step S505, the estimation processing unit 310 determines whether the result of the estimation processing satisfies a notification condition. More specifically, the estimation processing unit 310 determines that the notification condition is satisfied when the usage environment, as a result of the estimation processing, is different from the usage environment selected in the screen 401 and set to the MFP 100, and is different from the usage environment as a result of the last estimation processing. The estimation processing unit 310 determines that the notification condition is not satisfied when the usage environment, as a result of the estimation processing, is the same as the usage environment selected in the screen 401 and set to the MFP 100, and is the same as the usage environment as a result of the last estimation processing. When the estimation processing unit 310 determines that the notification condition is not satisfied (NO in step S505), the estimation processing unit 310 terminates the estimation processing without displaying a notification in the information display area 408.

When the estimation processing unit 310 determines that the notification condition is satisfied (YES in step S505), the processing proceeds to step S506. In step 506, the estimation processing unit 310 collaborates with the operation control unit 301 to display a notification to the information display area 408. More specifically, the estimation processing unit 310 displays a notification indicating that the usage environment, as a result of the estimation processing, is different from the usage environment selected in the screen 401 and set to the MFP 100. While in FIG. 4, the information display area 408 is displayed in the recommended security setting screen 401, this is not seen to be limiting. More specifically, while another screen is displayed on the operation unit 102, the information display area 408 is displayed at the bottom of the screen. After the power of the MFP 100 is turned ON, the estimation processing is executed even if the screen 401 is not displayed. When the currently set usage environment is different from the usage environment, as a result of the estimation processing, even in a state where another screen, e.g., the home screen is displayed, a notification is displayed at the bottom of the screen. This enables the user to recognize that review of the settings of the usage environment is needed. The notification displayed in the information display area 408 in step S506 is canceled when the recommended security setting screen 401 is displayed. The notification is also canceled when the power of the MFP 100 is turned OFF, and is not displayed the next time the power is turned ON.

When the operation control unit 301 receives a display instruction for the screen 401 after completion of the usage environment estimation, the operation control unit 301 displays the screen 401 displaying the usage environment, as a result of the latest estimation processing, as a recommended environment type 407 on the operation unit 102.

The control based on the flowchart illustrated in FIG. 5 is executed when the power of the MFP 100 is turned ON in step S501. However, similar control may be performed even if the usage environment estimation processing is executed when the screen is displayed or when a predetermined time period has elapsed. In another exemplary embodiment, the determination processing in step S505 may be omitted. For example, the estimation result may always be notified after execution of the estimation processing. The notification condition is not limited to thereto. For example, the notification condition may include only a condition whether the usage environment, as a result of the estimation processing, is different from the usage environment set to the MFP 100. The notification condition may also include only a condition whether the usage environment, as a result of the estimation processing, is different from the usage environment as a result of the last estimation processing.

According to the present exemplary embodiment, the processing of the flowchart illustrated in FIG. 5 enables control to prevent executing the estimation processing in specific operation modes. The processing also enables control to not issue a notification of the result of the estimation processing. Preventing the estimation processing from executing in specific operation modes enables avoiding unnecessary estimation processing and unnecessary notification issuance, thus avoiding possible user confusion. In addition, the processing of the flowchart illustrated in FIG. 5 enables selection of appropriate security setting(s) suitable for respective usage environment(s). Preventing the estimation processing from executing in specific operation modes enables avoiding user confusion when the user selects the usage environment.

FIG. 6 is a view illustrating an input/output structure using a learning model according to the present exemplary embodiment. A learning model (learned model) 601 inputs communication feature information 602 and outputs a usage environment 603. In the example according to the present exemplary embodiment, the usage environment 603 includes the patterns illustrated in the table in FIG. 8.

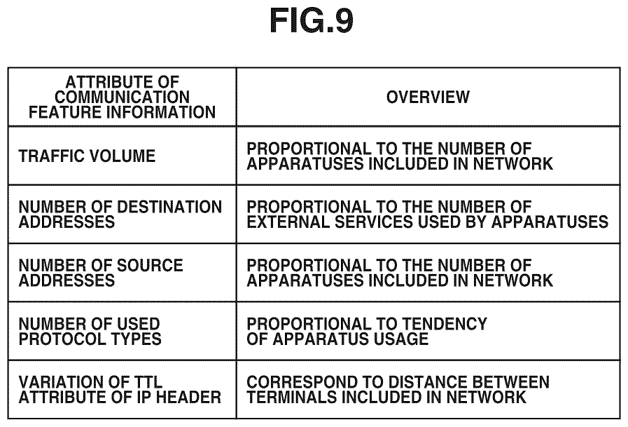

In the example according to the present exemplary embodiment, the communication feature information 602 includes the data illustrated in the table in FIG. 9.

The traffic volume refers to the number of communication packets communicated in unit time. Communications in which an apparatus connected to a network can receive data include unicast communication with the apparatus itself specified as destination, broadcast communication without destination specification, and multicast communication. The traffic volume in broadcast and multicast communications increases in proportion to the number of information apparatuses existing in the network. Therefore, the traffic volume is information that enables estimating the scale of the connected network. Unicast communication may be excluded to more definitely identify the network scale. The value of the traffic volume enables estimating which of a large-scale network (in-house intranet, Internet direct connection, or Internet prohibition environment), a middle-scale public space, and a small-scale home environment a usage environment is relatively highly likely to be. For example, a usage environment having a large traffic volume is highly likely to be a large-scale network including a large number of information apparatuses. A usage environment having a small traffic volume is highly likely to be a small-scale home environment. A usage environment having an intermediate traffic volume is highly likely to be a middle-scale public space environment.

The number of destination addresses refers to the number of destination address variations of communication packets communicated in unit time. Using increasing number of types of external services by apparatuses increases the number of destination addresses. A network that has an extremely small number of destination addresses is relatively highly likely to be an isolated network where communication is limited.

The number of source addresses refers to the number of source address variations of communication packets communicated in unit time. If a large number of information apparatuses exist in the network, the number of source addresses increases. The number of source addresses has a similar tendency to the traffic volume for each usage environment. However, since the number of source addresses is inherently different data from the traffic volume, the accuracy of usage environment estimation can be further improved by observing the tendency in combination with the traffic volume.

The number of protocol types refers to the number of protocol variations used by communication packets communicated in unit time. The number of protocol types increases in proportion to the number of information apparatuses connected to the network. In addition, in a network with strong functional limitations, the number of protocol types decreases. A usage environment having a small number of protocol types is highly likely to be an Internet prohibition or public space environment.

The number of variations of the Time to Live (TTL) attribute of the IP header refers to the number of variations of the TTL value accompanying communication packets communicated in unit time. Since the TTL value is decremented each time a communication packet passes through a router, a communication packet having passed through many routers has a small TTL value. A usage environment where communication packets have a uniformly large TTL value and a small number of TTL attribute variations is highly likely to be a small network. A usage environment where communication packets have large and small TTL values and a large number of TTL attribute variations is highly likely to be a large-scale network.

As described above, each parameter has a certain tendency to features such as the network scale and the like. However, it can be difficult to logically determine the threshold values for performing the determination. The usage environment is preferably estimated through composite determination based on a combination a plurality of parameters. Thus, the present exemplary embodiment executes the estimation processing based on a combination of the usage environment and the acquired communication feature information by using a learning algorithm. The threshold values can be determined by repetitively performing many tests even without using a learning algorithm. Therefore, the present technique is also applicable to such a method based on threshold values without using a learning algorithm.

With respect to the communication feature information as input data, the technique processes respective pieces of information (data) obtained from communicated communication packets to derive numerical vectors, thus improving the estimation accuracy. With respect to the traffic volume and TTL attribute variations, the technique pre-generates a histogram for each of the numbers in unit time by using learning data, and determines threshold values for dividing the data into, for example, five different ranges each including an equal amount of data. Based on the determined threshold values, the technique replaces the traffic volume and TTL attribute variations in unit time with integer values from 1 to 5 as corresponding range values, and uses the values as input data. While in the above-described example data is divided into five different ranges, the number of division ranges is any desired value and may be suitably set, for example, according to the value ranges of other parameter values.

With respect to the number of destination addresses, the number of source addresses, and the number of protocol types, the technique excludes data with a small number of occurrences (once or twice) in unit time, and then uses occurrence variations having unique values. This enables observing the communication tendency after excluding communications with low frequencies of occurrence. For example, for each of the number of destination addresses and the number of source addresses, the technique counts the number of packets including the same duplicated value, communicated in unit time. The technique selects packets in descending order of the number of duplications. When the ratio of the remaining packets to the total number of packets decreases to 1%, the technique uses the number of values that have been selected till the timing. For each of the destination and source addresses of packets communicated in unit time, the technique uses the number of addresses when the number of packets having been subjected to the extraction accounts for 99% of the total number of packets. Likewise, for the number of protocol types, the technique counts the number of packets including the same duplicated protocol type, communicated in unit time. The CPU 201 selects packets in descending order of the number of duplications. When the ratio of the remaining packets to the total number of packets decreases to 1%, the technique uses the number of protocol types that have been selected till the timing. For the protocol types used by packets communicated in unit time, the technique uses the number of protocol types when the number of packets having been subjected to the extraction accounts for 99% of the total number of packets. Since the number of protocol types falls within a range from 1 to 20 depending on the method for taking unit time, the CPU 201 uses this value. If the value largely exceeds 20, the CPU 201 may round the value to 20.

When collecting the number of destination addresses, the number of source addresses, and the number of protocol types, it is preferable to include breakdown information for these numbers. This is because the extraction for 90% of the total number of packets enables improving the tuning accuracy in learning to a further extent than the extraction for 99% of the total number of packets. For examples of breakdown information, the number of packets with address information 192.168.100.12 is 80, and the number of packets with address information 172.24.100.30 is 32. Since the IP address may be handled as individual information, it is preferable to collect the IP address with the address information concealed, for example, 192.168.100.12 as address A, and 172.24.100.30 as address B.

Generally, if the values of parameters having largely different value ranges are input to the learning algorithm as they are, the difference of the range value may affect the estimation accuracy. For example, if only the traffic volume has a value range from 1 to 10000, and other parameters have a value range from 1 to 10, the estimation result will be remarkably affected by the traffic volume. To use parameters in a balanced way, numerical vectors are derived and the difference in the value range is reduced to improve the estimation accuracy.

The learning model (learned model) 601 can be generated by collecting a number of samples of combinations of the communication feature information 602 as input data and the usage environment 603 corresponding to the output data in the real environment, and performing learning based on the samples. The present exemplary embodiment uses a one-dimensional array to represent parameters regarding the communication feature information 602 in unit time, samples the parameters several times, and arranges the parameters in time series to form a two-dimensional array. By using information about the two-dimensional array and the setting values of the usage environment, the CPU 201 generates a learned model based on a common algorithm for generating a Convolutional Neural Network (CNN) model. The CPU 201 may configure a classifier by using such algorithms as the k-nearest neighbor method and the support vector machine.

### <Modifications>

The above-described exemplary embodiment discussed an example where the operation mode control unit 312 manages the definition of operation modes as a condition for not executing the estimation processing. However, the management of the operation mode is not limited thereto. For example, the operation mode control unit 312 may manage the definition of operation modes as a condition for executing the environment estimation. More specifically, the operation mode control unit 312 may control the estimation processing by defining the normal mode as the operation mode for normally operating the MFP 100, and executing the estimation processing in the normal mode.

The operation mode control unit 312 may execute the estimation processing upon manual execution of the estimation processing even in an operation mode not including execution of the estimation processing, or upon detection of a mode change from an operation mode not including execution of the environment estimation to an operation mode including execution of the environment estimation.

In the above-described example, the operation mode control unit 312 controls display so that the Update Recommendations button 409 cannot be selected in an operation mode not including execution of the estimation processing. However, the present exemplary embodiment is not limited thereto. If the user intentionally requests execution of the estimation processing without controlling the Update Recommendations button 409, the operation mode control unit 312 may execute the environment estimation regardless of the operation mode.

### Other Exemplary Embodiments

The present disclosure can also be achieved when a program for implementing at least one of the functions according to the above-described exemplary embodiments is supplied to a system or apparatus via a network or storage medium, and at least one processor in the computer of the system or apparatus reads and executes the program. The present disclosure can also be achieved by a circuit, such as an Application Specific Integrated Circuit (ASIC) or Field Programmable Gate Array (FPGA), for implementing at least one of the above-described functions.

An image forming apparatus according to the exemplary embodiment of the present disclosure can control processing for estimating a usage environment.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-080806, filed May 17, 2024, which is hereby incorporated by reference herein in its entirety.

What is claimed is:

1. An image forming apparatus that communicates with an external apparatus, the image forming apparatus comprising:
at least one memory that stores a program; and
at least one processor that executes the program to perform:
controlling estimation processing for estimating a usage environment of the image forming apparatus using information based on communication packets communicated by the image forming apparatus; and
issuing a notification corresponding to a result of the estimation processing,
wherein, in a case where the image forming apparatus is set to a specific mode, control is performed to prevent the estimation processing from being executed.

2. The image forming apparatus according to claim 1, wherein the specific mode is a mode for communicating only with a specific external apparatus.

3. The image forming apparatus according to claim 1, wherein the specific mode is a mode for enabling the image forming apparatus to download firmware.

4. The image forming apparatus according to claim 1, wherein the specific mode is a mode for enabling the image forming apparatus to directly connect with an external apparatus to conduct maintenance.

5. The image forming apparatus according to claim 1, wherein the specific mode is a mode in a manufacturing process of the image forming apparatus.

6. The image forming apparatus according to claim 1, wherein the at least one processor executes the program to further perform:
controlling displaying of a screen for accepting a selection of the usage environment of the image forming apparatus; and
setting setting values corresponding to the selected usage environment to the image forming apparatus,
wherein the notification is issued in a case where the usage environment obtained as a result of the estimation processing is different from the usage environment that is selected in the screen and corresponding to which setting values are set to the image forming apparatus.

7. The image forming apparatus according to claim 6, wherein the result of the estimation processing is displayed on the screen.

8. The image forming apparatus according to claim 7,
wherein, in a case where power of the image forming apparatus is turned ON and the image forming apparatus is not set to a specific mode, the estimation processing is executed, and
wherein, as a result of the estimation processing, a result of latest estimation processing is displayed on the screen.

9. A method for controlling an image forming apparatus that communicates with an external apparatus, the method comprising:
controlling estimation processing for estimating a usage environment of the image forming apparatus using information based on communication packets communicated by the image forming apparatus; and
issuing a notification corresponding to a result of the estimation processing,
wherein, in a case where the image forming apparatus is set to a specific mode, control is performed to prevent the estimation processing from being executed.

10. A storage medium storing a computer program for executing a method for controlling an image forming apparatus that communicates with an external apparatus, the method comprising:
controlling estimation processing for estimating a usage environment of the image forming apparatus using information based on communication packets communicated by the image forming apparatus; and
issuing a notification corresponding to a result of the estimation processing,
wherein, in a case where the image forming apparatus is set to a specific mode, control is performed to prevent the estimation processing from being executed.
